(19) United States
(12) Patent Application Publication
(10) Pub. No.: US 2011/0086532 A1
(43) Pub. Date: Apr. 14, 2011

(54) Electrical Conduit Coupling Apparatuses and Adapters

(76) Inventor: Shawn Jackson, Clarkston, WA (US)

(21) Appl. No.: 12/576,182

(22) Filed: Oct. 8, 2009

(51) Int. Cl. H01R 13/62; H01R 24/00; H01R 27/02

(52) U.S. Cl. 439/345; 439/660; 439/638

(57) ABSTRACT

Electrical connection coupling apparatuses are provided that can include a male component encompassing an end of a first electrical conduit; a female component encompassing an end of a second electrical conduit, wherein when coupled the components define apposing parabolas with the wide ends of the parabolas opposing one another, and each parabola tapering to the electrical conduit. Electrical connection coupling apparatuses can include a recess extending along a lateral portion of the component; and a clasping assembly comprising a member having an end pivotably engaged within the recess, the member extending along its length to a flange. Receptacle adapters are provided that can include a body extending from a male coupling end to a female coupling end, the body defining sidewalls extending between the ends; a flange configured to couple the body to an electrical outlet; and a recess extending from the female coupling end along the body.

### TECHNICAL FIELD

The present disclosure relates to electrical conduit coupling apparatuses and adapters.

### BACKGROUND

When providing power to mobile equipment, the users of that mobile equipment are typically plagued by coupling to a source of power. A conduit to that power can become snagged on obstacles and/or obstructions that may lie in the path between the mobile equipment and the source of the power. These obstructions can include typical obstructions encountered at construction sites. For example, when utilizing a circular saw and providing power from a generating source such as a generator and/or site power, an extension cord or power conduit can become snagged, coiled, wrapped and/or caught on various obstructions, including other construction equipment and/or other power equipment, for example. In instances where the user encounters these difficulties, it would be beneficial to have a power coupling apparatus that was both resilient to the forces exerted on the apparatus, such as pulling forces and/or stretching forces, as well as substantially impervious to being snagged on obstructions. The present disclosure provides electrical connection coupling apparatuses as well as adapters.

### DRAWINGS

Embodiments of the disclosure are described below with reference to the following accompanying drawings.

FIG. 1 is an electrical connection coupling apparatus according to an embodiment of the disclosure.

FIG. 2 is an electrical connection coupling apparatus according to an embodiment of the disclosure.

FIG. 3 is another electrical connection coupling apparatus according to an embodiment of the disclosure.

FIG. 4 is another electrical connection coupling apparatus according to an embodiment of the disclosure.

FIG. 5 is another electrical connection coupling apparatus according to an embodiment of the disclosure.

FIG. 6 is an electrical coupling apparatus in a configuration according to an embodiment of the disclosure.

FIG. 7 is an electrical coupling apparatus in a configuration according to an embodiment of the disclosure.

FIG. 8 is an electrical coupling apparatus in a configuration according to an embodiment of the disclosure.

FIG. 9 is a receptacle adapter according to an embodiment of the disclosure.

FIG. 10 is another view of the receptacle adapter of FIG. 9 according to an embodiment of the disclosure.

FIG. 11 is another view of the receptacle adapter of FIG. 9 according to an embodiment of the disclosure.

### SUMMARY

An electrical connection coupling apparatus comprising: a male component encompassing an end of a first electrical conduit; a female component encompassing an end of a second electrical conduit, the female component configured to couple to the male component; and wherein when coupled the components define apposing parabolas with the wide ends of the parabolas opposing one another, and each parabola tapering to the electrical conduit.

An electrical connection coupling apparatus comprising: a connecting component encompassing a terminal end of an electrical conduit, the component defining a parabola extending from a terminal end to a conduit encompassing end; a recess extending along a lateral portion of the component; and a clasping assembly comprising a member having an end pivotably engaged within the recess, the member extending along its length to a flange.

A receptacle adapter configured to couple with an electrical coupling apparatus, the adapter comprising: a body extending from a male coupling end to a female coupling end, the body defining sidewalls extending between the ends; a flange configured to couple the body to an electrical outlet; and a recess extending from the female coupling end along the body.

### DESCRIPTION

This disclosure is submitted in furtherance of the constitutional purposes of the U.S. Patent Laws “to promote the progress of science and useful arts” (Article 1, Section 8).

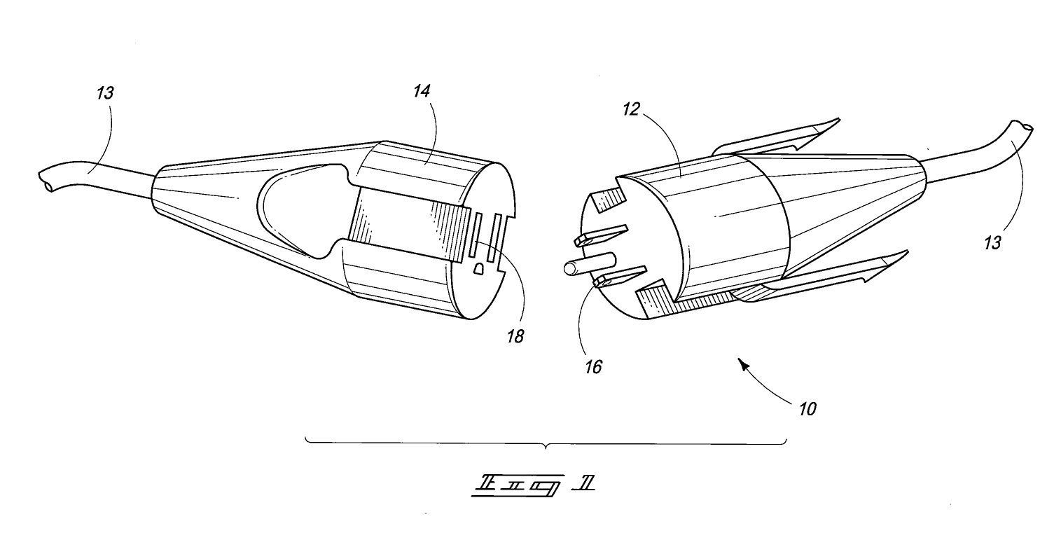

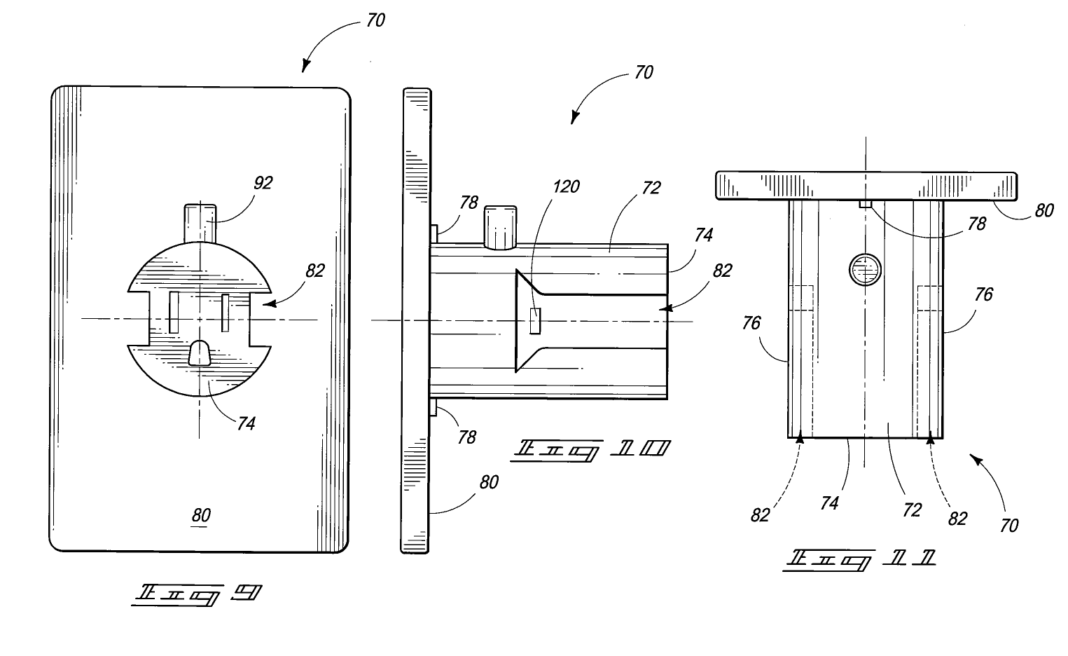

The electrical conduit coupling apparatuses and adapters of the present disclosure will be described with reference to FIGS. 1-11. Referring first to FIG. 1, an electrical conduit coupling apparatus 10 is shown that includes one component encompassing an electrical conduit 13 and another component 14 configured to couple with the one component 12. The one component 12 can be referred to as the male component, and this male component can include a plug configuration 16. Plug configuration 16 can be configured as the 3-prong plug shown or other plug configurations including 2-prong, high voltage, or USB configurations. The other component 14 can be considered the female component, and in this configuration, the female component can include an outlet configuration 18. In this example depiction, outlet component 18 can be configured to receive a 3-prong plug as is depicted in plug configuration 16. Component 14 can typically encompass another electrical conduit engaged with a power source or device requiring power, for example.

Apparatus 10 can be constructed of a molded plastic or hardened polymer, for example. The plastics themselves or construction materials can be hardened in certain cases. The components 14 and 12 may be rubberized as well.

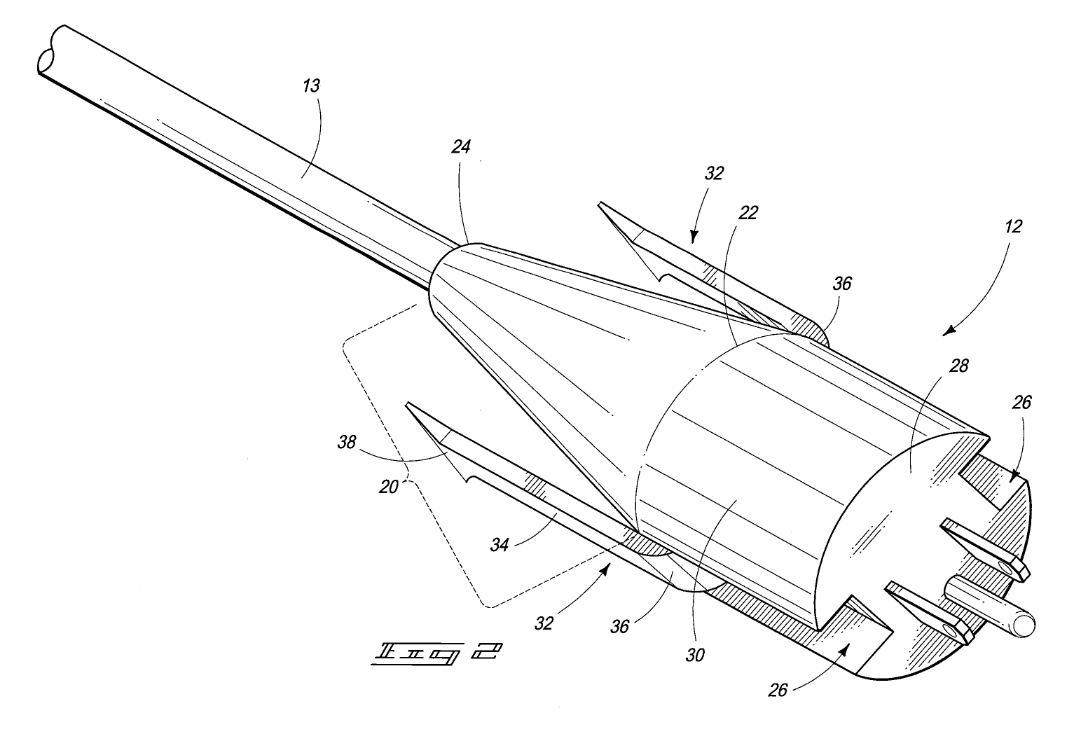

Referring to FIG. 2, component 12 is shown in more detail. Connecting component 12 can be the terminal end of electrical conduit 13, for example. Component 12 can define a tapered portion 20 extending from a broad to a narrow end as a cone or parabola for example. Component 12 can extend from a terminal end 22 to conduit encompassing end 24. It is not necessary that the sidewalls of the parabola portion of component 12 be curved; they can be substantially straight as well. Component 12 can be implemented with terminal end 22 broader than conduit encompassing end 24. In one cross-section of component 12, the angle at which the sidewall of portion 20 extends from end 24 to end 22 can be an angle of less than 40 degrees from the narrow end to the broad end of component 12. According to other example implementations, this angle can be less than 30 degrees and/or less than 20 degrees, for example.

Component 12 can also include a recess 26 extending along at least a sidewall portion of component 12. This recess 26 may also have a complimentary recess on the opposing side of component 12, for example wherein component 12 may have multiple recesses. Recess 26 can provide an opening in a face 28 of component 12 as well. Face 28 may be substantially flat or may be curved to compliment an abutting face of component 14 or adapters that may be utilized in conjunction with component 12. Component 12 can also include a barrel portion 30 extending from face portion 28 to terminal end 22. Portion 20 may be longer than barrel portion 30, for example. According to example implementations, portion 20 may be as much as twice as long as barrel portion 12.

Component 12 may also include clasping assemblies 32. These clasping assemblies can include a member 34 having an end 36 pivotably engaged within recess 26. Member 34 extends to define a flange portion 38. Flange portion 38 can flare outwardly from the lateral walls defined by member 34, for example.

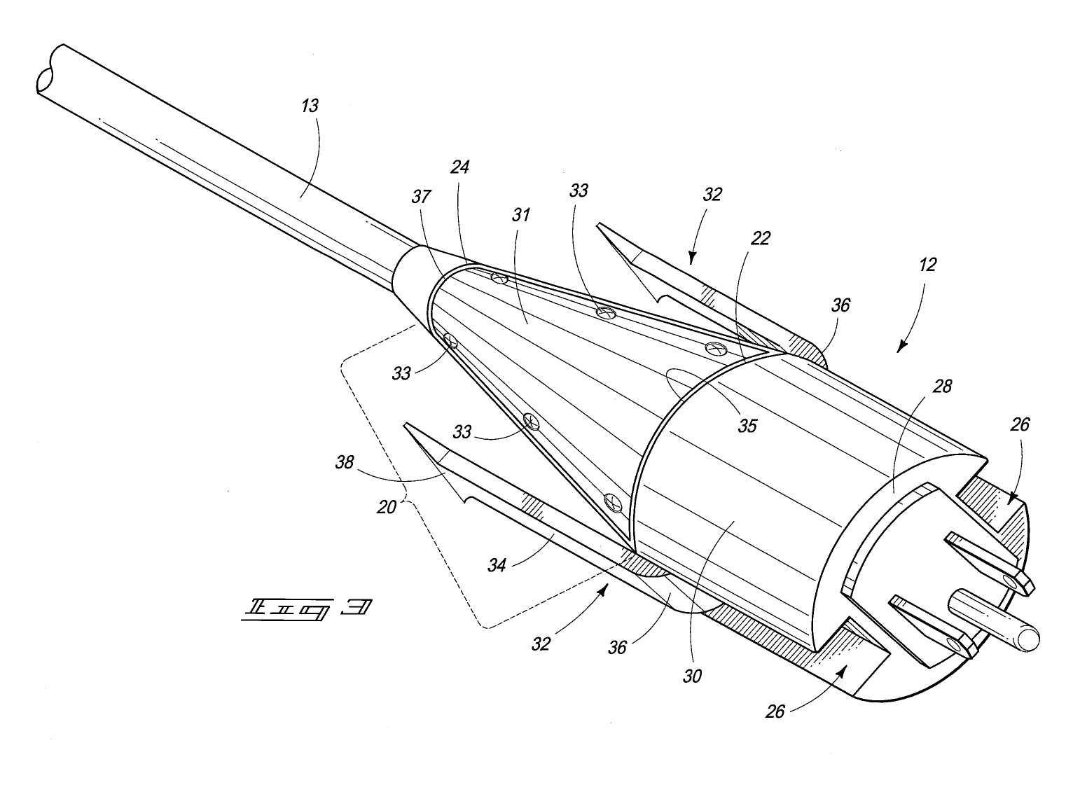

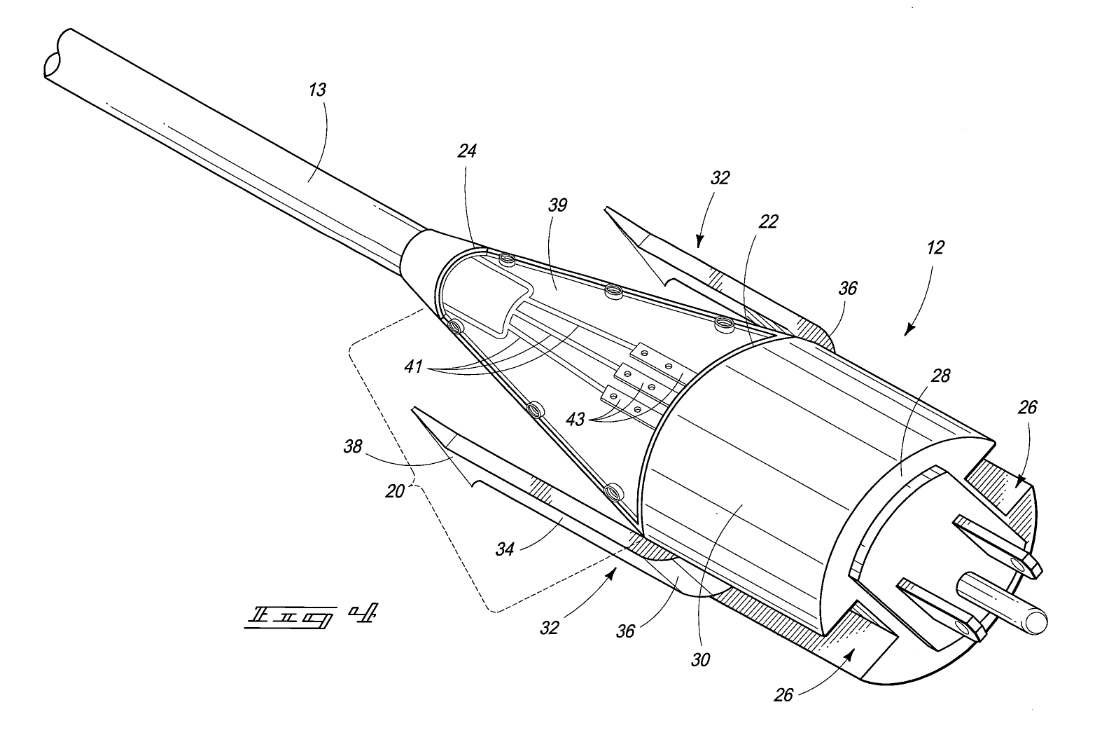

Referring to FIG. 3, component 12 may also include a plate 31 extending from portion 30 to end 24, and complimenting same ends 35 and 37 respectively. Plate 31 can be affixed to component 12 with fasteners 33, such as threaded fasteners. Referring to FIG. 4, plate 31 can cover opening 39. Opening 39 can be configured to receive electrical conduits from component 13. The conduits can be separate conduits 41, for example. According to example implementations, these separate conduits can be coupled to component 30 via electrical connectors 43.

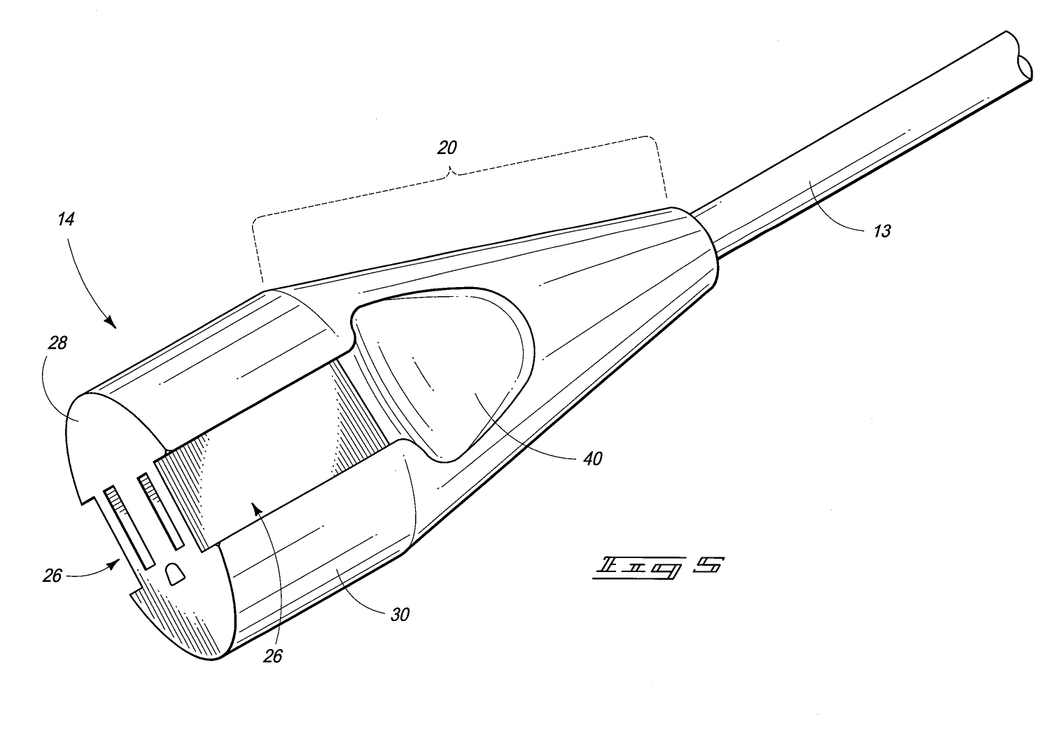

Referring to FIG. 5, component 14 is shown, and component 14 can include a face 28 extending to a portion 20. Portion 20 can be an alternate image of that defined by portion 20 of component 12, for example a mirror image. However, portion 20 of component 14 may also be a different design than the portion 20 of component 12. Component 14 can also include recess 26. Recess 26 can be complimentary to recess 26 defined by component 12 in that recess 26 may be configured to receive all or a portion of assembly 32 when extended to clasp component 14, for example.

Component 14 can also include an opening 40. Opening 40 can extend to within at least a portion of portion 20 and opening 40 can be configured to receive a portion and/or all of the flange portion of member 34 of assembly 32. According to example implementations, opening 40 can be large enough to allow for the removal of flange portion from opening 40 to unclasp component 12 from component 14.

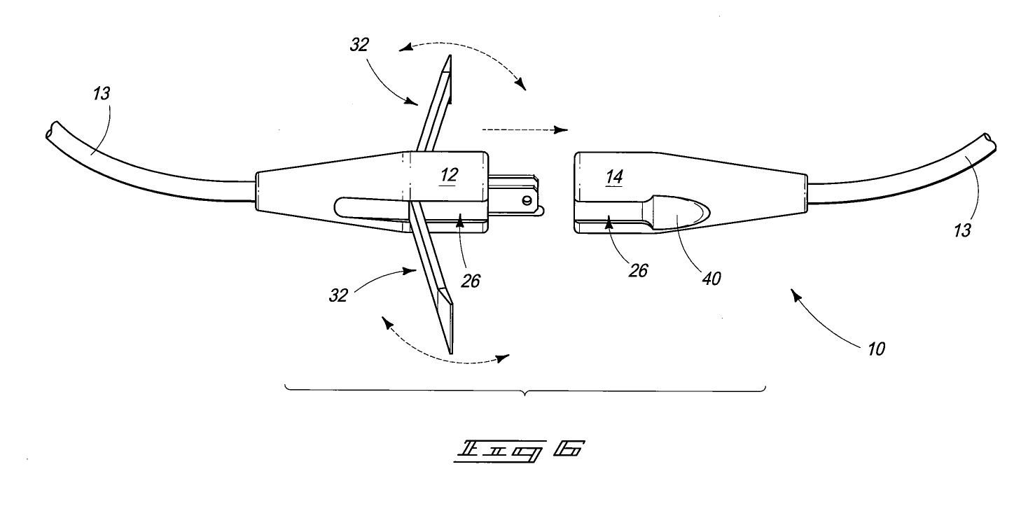

Referring to FIG. 6, apparatus 10 is shown in a configuration wherein component 12 abuts or faces component 14. As can be seen in FIG. 6, assembly 32 is shown in an extended position pivotably engaged with recess 26. Referring to FIG. 7, and in accordance with another configuration, components 14 and 12 are engaged at the plug and outlet but are not engaged at the clasping assembly.

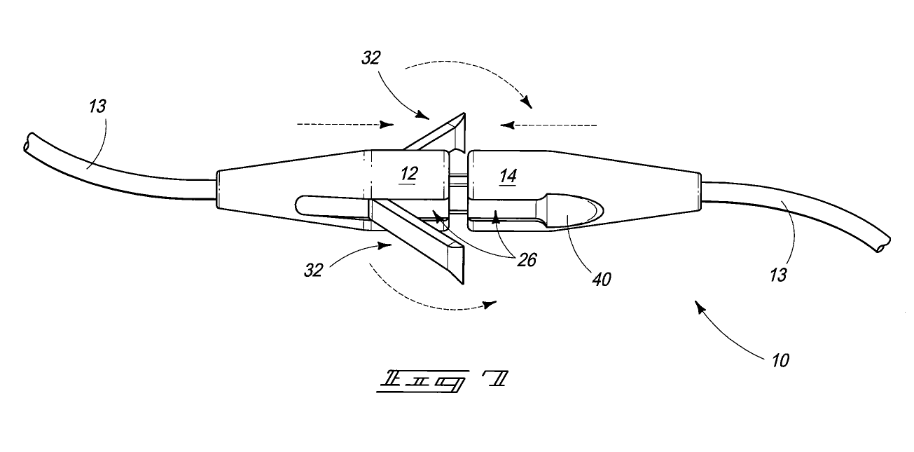

Referring to FIG. 8, components 12 and 14 are engaged and coupled with clasping assembly 32. When coupled, the components define opposing parabolas with the wide ends of the parabolas opposing one another and each parabola tapering to electrical conduit 13. When coupled, the barrel portions abut and can extend between the opposing parabolas, and/or the barrel portions can be at least about a third of the overall length of the coupled components.

As is depicted, opening 40 can be configured to receive a portion of clasping assembly 32. Recess 26 can extend to within the tapered or parabolic portion 20 of either or both of components 12 and 14. When coupled for example, recesses 26 can align to form a continuous recess extending between the coupled components. Opening 40 can be defined to receive the distal portion of assembly 32 which can include the flared or flanged portion 38. Opening 40 can define an outward opening configured to receive the flanged portion 38 of assembly 32.

As depicted in the FIGS. 6-8, for example, assembly 32 can pivotably rotate 180° to the lateral sidewall of component 12 in the extreme open position as shown in FIG. 4 to the clasping position as shown in FIG. 8, for example. The recess of the component receiving to engage the clasping assembly 32 can have a deeper recess to within the component. For example, this deeper recess may provide for when a resilient member 34 is utilized that the operator can apply pressure towards a point over the opposing assembly that will provide pressure disengaging the flange portion 38 from opening 40.

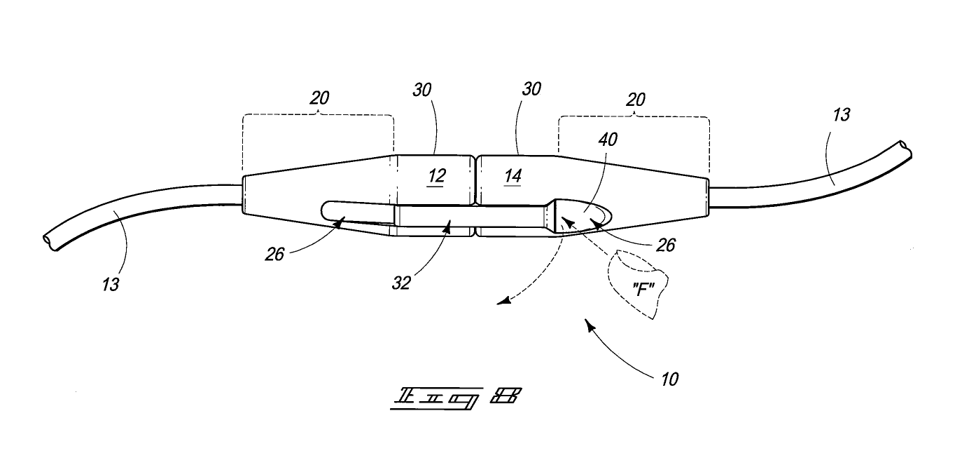

Referring to FIGS. 9-11, a receptacle adapter 70 configured to couple with an electrical coupling apparatus is shown. Adapter 70 can include a body 72 extending from a male coupling end to a female coupling end 74. The male coupling end can include for example the classic pronged configuration extending from a face. Along the face can be flange 78. This flange can be configured to couple with the outlet. For example, the classic domestic outlet includes a threaded coupler to be utilized for coupling the outlet cover to the outlet. Flange 78 can be configured to couple with this threaded coupler. Adapter 70 can be constructed of a molded plastic or hardened polymer, for example. The plastics themselves or construction materials can be hardened in certain cases.

The body 72 can define sidewalls 72 extending between the ends. Body 72 can define a recess 82 extending from the female coupling end 74 along the body 72. Recess 82 may extend to a terminal end that includes an opening configured to receive a flanged member such as member 34 of clasping member 32, for example. The recess 82 can define depths along body 72. The depth of the recess proximate the female coupling end can be the greatest of any depth of recess 82. By providing this depth, it can facilitate the disengagement of clasping assembly 32 from adapter 70 through the operation of exerting pressure along a resilient member 34 to disengage flange member 38 from opening 84, for example.

A biased post 92 can extend from the body 72. The post can be mechanically connected to extensions 120 that slidably engage body 72 at a distal portion of recess 82. In operation, apparatus user can clasp an assembly to body 72 utilizing clasps 40. To disengage clasps 40, post 92 can be depressed extending extensions 120 to release clasps 40.

The apparatuses and assembly described herein can be utilized to facilitate an improved interconnection of electrical conduits that can allow for a more efficient use of operator time with portable electrical equipment.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

What is claimed is:

1. An electrical connection coupling apparatus comprising:
a male component encompassing an end of a first electrical conduit;
a female component encompassing an end of a second electrical conduit, the female component configured to couple to the male component; and
wherein when coupled the components define apposing parabolas with the wide ends of the parabolas opposing one another, and each parabola tapering to the electrical conduit.

2. The apparatus of claim 1 wherein the coupled components further define a barrel portion between the opposing parabolas.

3. The apparatus of claim 2 wherein the barrel portion is at least about a third of the overall length of the coupled components.

4. The apparatus of claim 1 wherein one of the components is pivotably coupled to a clasping assembly.

5. The apparatus of claim 4 wherein at least the one component includes at least one recess, the clasping assembly pivotably mounting to the one component within the one recess.

6. The apparatus of claim 5 wherein another of the components is configured to receive a portion of the clasping assembly.

7. The apparatus of claim 6 wherein the other component includes another recess configured to receive the clasping assembly.

8. The apparatus of claim 7 wherein the one or the other recess extends to within the tapered portion of one or the other components.

9. The apparatus of claim 4 wherein the clasping assembly includes a member pivotably coupled within the one recess, the member extending to define a flanged portion at the opposing end.

10. The apparatus of claim 9 wherein the flange portion flares outwardly from the lateral walls defined by the member.

11. The apparatus of claim 10 wherein another recess is defined by the other of the components, the one and other recesses aligning to form a continuous recess when the components are coupled.

12. The apparatus of claim 11 wherein the one and the other components further define an opening at one end of the recess, the opening configured to receive the distal end of the member of the clasping assembly.

13. The apparatus of claim 12 wherein the opening is defined along the tapered portion of the component, the opening extending outwardly from the recess to receive a flanged portion of the distal end of the member of the clasping assembly.

14. An electrical connection coupling apparatus comprising:
a connecting component encompassing a terminal end of an electrical conduit;
the component defining a parabola extending from a terminal end to a conduit encompassing end;
a recess extending along a lateral portion of the component; and
a clasping assembly comprising a member having an end pivotably enganged within the recess, the member extending along its length to a flange.

15. The apparatus of claim 14 wherein the tapered portion of the parabola defined by the component extends at an angle of less than 40 degrees from the narrow end to the broad end of the component.

16. The apparatus of claim 14 wherein the tapered portion of the parabola defined by the component extends at an angle of less than 30 degrees from the narrow end to the broad end of the component.

17. The apparatus of claim 14 wherein the tapered portion of the parabola defined by the component extends at an angle of less than 20 degrees from the narrow end to the broad end of the component.

18. The apparatus of claim 14 wherein the member of the clasping assembly is configured to rotate at least 180 degrees in relation to the sidewalls of the component.

19. A receptacle adapter configured to couple with an electrical coupling apparatus, the adapter comprising:
a body extending from a male coupling end to a female coupling end,
the body defining sidewalls extending between the ends;
a flange configured to couple the body to an electrical outlet; and
a recess extending from the female coupling end along the body.

20. The method of claim 19 wherein the recess defines depths along the body, the depth of the recess proximate the female coupling end being the greatest of any depth of the recess.
